(19) United States
(12) Patent Application Publication
(10) Pub. No.: US 2022/0305704 A1
(43) Pub. Date: Sep. 29, 2022

(54) CARBON FIBER COMPOSITE MATERIAL CONTAINING RECYCLED CARBON FIBERS, MOLDED BODY, AND METHOD FOR PRODUCING CARBON FIBER COMPOSITE MATERIAL

(71) Applicant: Shibaura Machine Co., Ltd., Tokyo (JP)

(72) Inventors: Takafumi SAMESHIMA, Tokyo (JP); Yoshio IIZUKA, Tokyo (JP); Kaho OSADA, Tokyo (JP)

(73) Assignee: Shibaura Machine Co., Ltd., Tokyo (JP)

(21) Appl. No.: 17/612,559

(22) PCT Filed: May 18, 2020
(86) PCT No.: PCT/JP2020/019673

§ 371 Date: Nov. 18, 2021

(30) Foreign Application Priority Data
May 21, 2019 (JP) 2019-095502

(51) Int. Cl. B29C 45/00; C08J 5/04; B29C 45/60

(52) U.S. Cl. CPC B29C 45/0005; C08J 5/042; B29C 45/0001; B29C 45/60; B29K 2077/00

(57) ABSTRACT

Provided are a carbon fiber composite material having high strength and elasticity and containing recycled carbon fibers, and a method for producing same. When a raw material is transported along the outer circumferential surface of a screw main body 37 having a passage 88 therein, the transport of the raw material is restricted by a barrier portion 82 provided on the outer circumferential surface, a shearing force is applied to the raw material by the screw main body 37, and a stretching force is applied to the raw material by passing the raw material from the inlet 91 of the passage 88 provided on the outer circumferential surface to the outlet 92 of the passage 88, thereby obtaining a carbon fiber composite material having good strength and elasticity and containing 50-70 wt % of recycled carbon fibers well dispersed therein.

### TECHNICAL FIELD

The present invention relates to a composite material that contains recycled carbon fibers extracted from waste from aircrafts or automobiles and has conductive properties, a molded body, and a method for producing a carbon fiber composite material.

### BACKGROUND ART

Carbon fiber reinforced materials (CFRPs) containing carbon fibers have high strength and high rigidity and are advantageous for weight reduction and are thus used as components for aircrafts, automobiles and the like. Since carbon fibers that are contained in carbon fiber reinforced materials are expensive, there has been a proposal of a method for producing recycled carbon fibers by extracting carbon fibers that are contained in CFRPs that have already been used (for example, Patent Literature 1).

### CITATION LIST

### Patent Literature

Patent Literature 1: Japanese Patent Laid-Open No. 2017-82037

### SUMMARY OF INVENTION

### Technical Problem

If it were possible to produce carbon fiber composite materials having high strength and elasticity using inexpensive recycled carbon fibers in place of expensive unused carbon fibers (hereinafter, appropriately referred to as “carbon fibers”), such a method would be preferable from the viewpoint of economic efficiency and alleviation of the burden on the environment. However, ordinarily, recycled carbon fibers produced from CFRPs that have been used have poor mechanical characteristics compared with unused carbon fibers due to the influences of production steps. Therefore, it has been difficult to produce resin composite materials having excellent strength and elasticity using recycled carbon fibers in place of unused carbon fibers. In addition, since recycled carbon fibers are poorly dispersible in composite materials, in the related art, it has been difficult to blend recycled carbon fibers at a high concentration of higher than 50 wt %. When recycled carbon fibers blended at a high concentration are poorly dispersible, there has been a problem that initial fracturing may be induced from a portion where the recycled carbon fibers have agglomerated and the strength and elasticity of composite materials may be degraded.

Therefore, an objective of the present invention is to provide a carbon fiber composite material having high strength and elasticity and containing recycled carbon fibers and a method for producing the same.

### Solution to Problem

The present invention is based on a finding that a method of applying a shearing force and a stretching force makes it possible to blend recycled carbon fibers into a carbon fiber composite material at a high concentration of higher than 50 wt % in a highly dispersible manner and has the following configuration.

A carbon fiber composite material of the present invention is a carbon fiber composite material containing a resin and recycled carbon fibers, in which the content of the recycled carbon fibers is 50-70 wt %.

A method for producing a carbon fiber composite material of the present invention is a method for producing a carbon fiber composite material by melting, kneading and continuously discharging a raw material containing a resin and recycled carbon fibers, in which the raw material contains 50-70 wt % of the recycled carbon fibers, when the raw material is transported along an outer circumferential surface of a screw main body having a passage therein, the transport of the raw material is restricted by a barrier portion provided on the outer circumferential surface, a shearing force is applied to the raw material by the screw main body, and a stretching force is applied to the raw material by passing the raw material from an inlet of the passage provided on the outer circumferential surface to an outlet of the passage.

### Advantageous Effects of Invention

Application of a shearing force and a stretching force at the time of melting and kneading the resin and the recycled carbon fibers makes it possible to disperse the recycled carbon fibers at a high concentration in the resin. Therefore, it is possible to increase the content of the recycled carbon fibers in the carbon fiber composite material while keeping the recycled carbon fibers well dispersed. The increase in the content of the recycled carbon fibers imparts high strength and elasticity to the carbon fiber composite material. In addition, it is possible to provide a highly isotropic molded body in which the anisotropy of mechanical characteristics is suppressed by injecting molding of the carbon fiber composite material containing a high concentration of the recycled carbon fibers.

### BRIEF DESCRIPTION OF DRAWINGS

FIG. 1 is a perspective view schematically showing a continuous high shear processing apparatus that is used in a production method of the present invention

FIG. 2 is a cross-sectional view of a first extruder in the continuous high shear processing apparatus FIG. 3 is a perspective view showing a state where two screws of the first extruder are engaged with each other

FIG. 4 is a cross-sectional view of a third extruder in the continuous high shear processing apparatus

FIG. 5 is a cross-sectional view of a second extruder in the continuous high shear processing apparatus

FIG. 6 is a cross-sectional view of the second extruder showing a barrel and a screw together in a cross section of the second extruder

FIG. 7 is a cross-sectional view along a F15-F15 line in FIG. 6

FIG. 8 is a perspective view of a tube

FIG. 9 is a side view showing a flow direction of a raw material with respect to the screw

FIG. 10 is a cross-sectional view of the second extruder schematically showing the flow direction of the raw material when the screw rotates

FIG. 11 is a cross-sectional view of a portion corresponding to FIG. 7 showing an example in which a plurality of passages is provided in parallel

FIG. 12 shows (a) a graph showing tensile strength and flexural modulus and (b) a graph showing specific rigidity and specific strength of the examples and the comparative examples

### DESCRIPTION OF EMBODIMENTS

[Carbon Fiber Composite Material]

A carbon fiber composite material of the present invention contains a resin and 50-70 wt % of recycled carbon fibers. A production method of the present invention in which a continuous high shear processing apparatus is used makes it possible to produce a carbon fiber composite material in which recycled carbon fibers are dispersed in a favorable state at a high concentration of 50-70 wt %. Recycled carbon fibers being contained at a high concentration provide favorable mechanical characteristics such as strength and elasticity to carbon fiber composite materials. In the present invention, a numerical range “A-B” means “A or more and B or less”.

The content of the recycled carbon fibers in the carbon fiber composite material is preferably 53 wt % or more and more preferably 58 wt % or more from the viewpoint of increasing the strength and elasticity of the composite material. In addition, the content of the recycled carbon fibers is preferably 68 wt % or less and more preferably 63 wt % or less from the viewpoint of providing excellent continuous processability to the carbon fiber composite material.

In the scope of the recycled carbon fibers, carbon fibers collected from carbon fiber reinforced materials (CFRP) that have been used as components or the like of aircrafts are included. At the time of collecting (recycling) carbon fibers, a method for separating a resin from the carbon fibers that are contained in carbon fiber reinforced materials is not limited, and examples thereof include a thermal decomposition method, a chemical dissolution method and the like. In the scope of the recycled carbon fibers, in addition to carbon fibers collected from carbon fiber-reinforced materials (CFRP), residues (textile materials, non-crimp fabrics or the like) of unused carbon fibers generated in production steps may also be included.

From the viewpoint of increasing the tensile strength of the carbon fiber composite material, the aspect ratios of the recycled carbon fibers are preferably 3.4-4.0 and more preferably 3.5-3.9. From the same viewpoint, the fiber length (D50) of the recycled carbon fibers is preferably 100 μm or more and more preferably 105 μm or more. In addition, from the viewpoint of decreasing the anisotropy of the mechanical characteristics of a molded body obtained by the injection molding of the carbon fiber composite material, the fiber length (D50) of the recycled carbon fibers is preferably 150 μm or less and more preferably 120 μm or less.

The resin that is contained in the carbon fiber composite material is not particularly limited, but is preferably a thermoplastic resin since thermoplastic resins can be easily kneaded with the recycled carbon fibers under heating conditions. Examples of the thermoplastic resin include polypropylene (PP), polysulfone (PS), polyethylene terephthalate (PET), polybutylene terephthalate (PBT), polyether sulfone (PES), polyphenylene sulfide (PPS), polyether ketone (PEK), polyether ether ketone (PEEK), aromatic polyamides (PA), aromatic polyesters, aromatic polycarbonates (PC), polyether imide (PEI), polyarylene oxide, thermoplastic polyimides and polyamide-imides. These resins may be used singly or two or more thereof may be jointly used.

The carbon fiber composite material may contain components other than the above-described resin and recycled carbon fibers. Examples of the components that may be contained include additives such as a (sulfur-based or phosphorus-based) antioxidant, carboxylic anhydride, maleic acid, a plasticizer, a UV absorber, a flame retardant and a crystal nucleating agents, a variety of fillers (carbon black, talc, metal powder, CNT, silica particles and mica) and the like, and the amount of the components blended is set in a range where the strength and the elasticity suitable for the application of the carbon fiber composite material can be maintained.

[Molded Body]

Ordinarily, carbon fiber composite materials containing recycled carbon fibers at a high concentration are rigid and have a high melt viscosity and are thus not suitable for injection molding. However, in the carbon fiber composite material of the present embodiment, the recycled carbon fibers are blended at a high concentration in a well-dispersed manner, and thus the carbon fiber composite material has appropriate fluidity. Therefore, it is possible to form a molded body by injection molding.

In the carbon fiber composite material of the present invention, the recycled carbon fibers can be blended at a high concentration of 50-70 wt % by the production method of the present invention in which a shearing force and a stretching force are applied to a raw material while a state where the resin and the recycled carbon fibers are well dispersed is maintained. Molding of the composite material in which the recycled carbon fibers are blended at a high concentration makes it possible to obtain a molded body having high strength and elasticity.

The mechanical characteristics of a molded body formed by the injection molding of the carbon fiber composite material of the present invention become less anisotropic (more isotropic) than those of CFRPs containing unused carbon fibers. This is considered to be related to the fact that the fiber lengths of the recycled carbon fibers become short at the time of kneading the resin and the recycled carbon fibers by the production method of the present invention. That is, this is considered to be because the recycled carbon fibers having relatively short fiber lengths are contained at a high concentration of 50 wt % or more, whereby the orientation of the recycled carbon fibers in a flow direction during injection molding deteriorates and the recycled carbon fibers are almost randomly oriented. From the viewpoint of decreasing the anisotropy of the molded body, the fiber length (D50) of the recycled carbon fibers is preferably 150 μm or less and more preferably 120 μm or less.

From the carbon fiber composite material of the present invention, a molded body having large ratios (TD/MD) (small anisotropy) between the mechanical characteristics in a transverse direction (TD, a direction in which the mechanical characteristics are poor) and the mechanical characteristics in a flow direction (MD, a direction in which the mechanical characteristics are favorable) during injection molding can be obtained. As the mechanical characteristics of the molded body, tensile strength and tensile elastic modulus are exemplified. The injection molding of the carbon fiber composite material of the present invention makes it possible to obtain a molded body having suppressed anisotropy in which the ratio (TD/MD) of the tensile strength is 0.75 or more and the ratio (TD/MD) of the tensile elastic modulus is 0.85 or more. The ratios of the mechanical characteristics refer to values that are obtained by measurement methods described in examples, and, as the ratios (TD/MD) of the mechanical characteristics become closer to 1.0, the anisotropy of the molded body becomes poorer (the isotropy becomes more favorable).

(Method for Producing Carbon Fiber Composite Material)

The above-described carbon fiber composite material of the present invention can be produced by applying a shearing force to a raw material containing a resin and recycled carbon fibers with a screw main body having a passage therein by restricting the transport of the raw material with a barrier portion provided on an outer circumferential surface of the screw main body and applying a stretching force to the raw material by passing the raw material from an inlet of the passage provided on the outer circumferential surface to an outlet of the passage at the time of transporting the raw material containing 50-70 wt % of the recycled carbon fibers along the outer circumferential surface using a continuous high shear processing apparatus that melts, kneads and continuously discharges the raw material.

The production method of the present invention will be described below with reference to the continuous high shear processing apparatus.

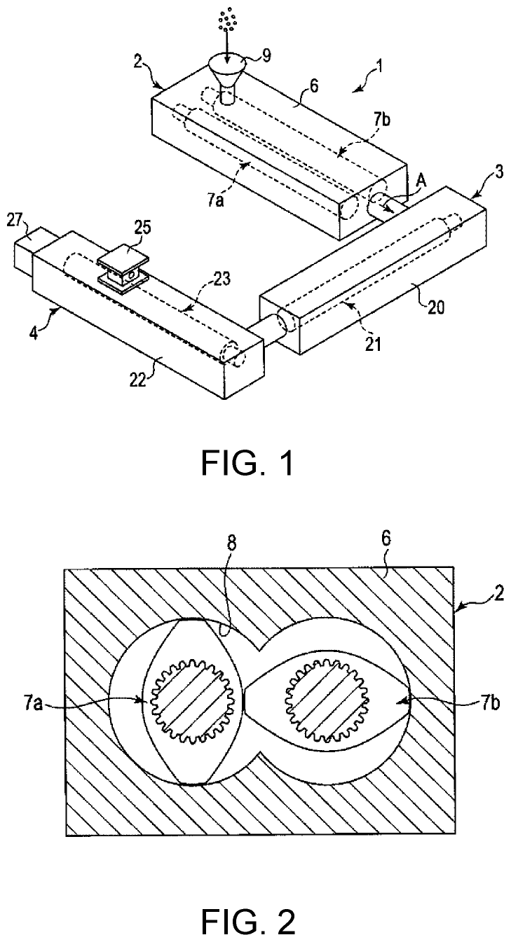

FIG. 1 schematically shows the configuration of a continuous high shear processing apparatus (kneading apparatus) 1 according to a first embodiment. The continuous high shear processing apparatus 1 includes a first extruder (treatment device), a second extruder 3 and a third extruder (defoaming device) 4. The first extruder 2, the second extruder 3 and the third extruder 4 are connected to each other in series.

The first extruder 2 is a treatment device for preliminary kneading and melting a raw material containing a resin and recycled carbon fibers. These raw materials are supplied to the first extruder 2 in a state of, for example, pellets, powder or the like in the case of the resin and in a state of short fiber chops cut to 3-10 mm in the case of the recycled carbon fibers.

In the present embodiment, in order to intensify the degree of kneading and melting of the raw material, a co-rotating twin-screw kneader is used as the first extruder 2. FIG. 2 and FIG. 3 disclose an example of the twin-screw kneader. The twin-screw kneader includes a barrel 6 and two screws 7a and 7b accommodated inside the barrel 6. The barrel 6 includes a cylinder portion 8 having a shape of two cylinders combined together. The resin is continuously supplied to the cylinder portion 8 from a supply port 9 provided at one end portion of the barrel 6. Furthermore, the barrel 6 includes a heater for melting the resin therein.

The screws 7a and 7b are accommodated in the cylinder portion 8 in a state of engaging with each other. The screws 7a and 7b receive a torque that is transmitted from a motor, not shown, and rotate in the same direction. As shown in FIG. 3, the screws 7a and 7b each include a feeding portion 11, a kneading portion 12 and a pumping portion 13. The feeding portion 11, the kneading portion 12 and the pumping portion 13 are arranged in a row along the axial direction of the screw 7a or 7b.

The feeding portion 11 has spirally twisted flights 14. The flights 14 of the screws 7a and 7b rotate in a state of engaging with each other and transport the material that contains the recycled carbon fibers and the resin and is supplied from the supply port 9 to the kneading portion 12.

The kneading portion 12 has a plurality of discs 15 arranged in the axial direction of the screws 7a and 7b. The discs 15 of the screws 7a and 7b rotate in a state of facing each other and preliminarily knead the material containing the recycled carbon fibers and the resin sent from the feeding portion 11. The kneaded material is sent into the pumping portion 13 by the rotation of the screws 7a and 7b.

The pumping portion 13 has spirally twisted flights 16. The flights 16 of the screws 7a and 7b rotate in a state of engaging with each other and eject the preliminarily kneaded material from a discharge end of the barrel 6.

According to the twin-screw kneader as described above, the resin in the material supplied to the feeding portion 11 of the screws 7a and 7b receives shear heating associated with the rotation of the screws 7a and 7b and heat from the heater and melts. The resin and the recycled carbon fibers melted by the preliminary kneading with the twin-screw kneader configure the blended raw material. The raw material is continuously supplied to the second extruder 3 from the discharge end of the barrel 6 as shown by an arrow A in FIG. 1.

Furthermore, since the twin-screw kneader is used as the first extruder 2, not only is the resin melted, but a shearing action can also be imparted to the resin and the recycled carbon fibers. Therefore, at a point in time where the raw material is supplied to the second extruder 3, the raw material has been melted by the preliminary kneading in the first extruder 2 and has an appropriate viscosity. In addition, since the twin-screw kneader is used as the first extruder 2, it is possible to stably supply the raw material in a predetermined amount per unit time at the time of continuously supplying the raw material to the second extruder 3. Therefore, it is possible to reduce burdens on the second extruder 3 in which the raw material is authentically kneaded.

The second extruder 3 is an element for generating a kneaded substance in which the recycled carbon fibers are highly dispersed in the resin component of the raw material. In the present embodiment, a single-screw extruder is used as the second extruder 3. The single-screw extruder includes a barrel 20 and one screw 21. The screw 21 has a function of repeatedly imparting a shearing action and a stretching action to the molten raw material. The configuration of the second extruder 3 including the screw 21 will be described below in detail.

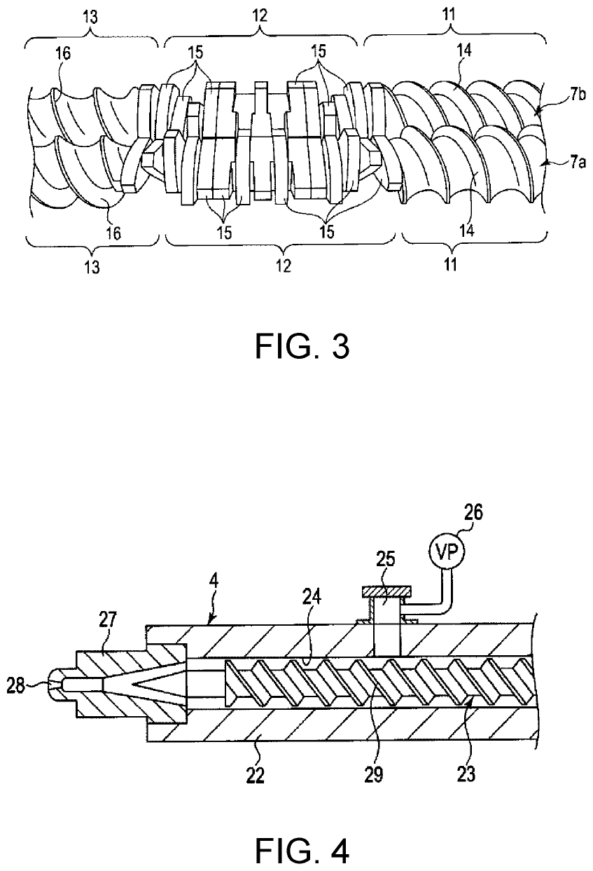

The third extruder 4 is an element for suctioning and removing a gas component that is contained in the kneaded substance discharged from the second extruder 3. In the present embodiment, a single-screw extruder is used as the third extruder 4. As shown in FIG. 4, the single-screw extruder includes a barrel 22 and one vent screw 23 accommodated in the barrel 22. The barrel 22 includes a straight cylindrical cylinder portion 24. The kneaded substance ejected from the second extruder 3 is continuously supplied into the cylinder portion 24 from one end portion of the cylinder portion 24 along the axial direction.

The barrel 22 has a vent port 25. The vent port 25 is open in the central portion of the cylinder portion 24 in the axial direction and is connected to a vacuum pump 26. Furthermore, the other end portion of the cylinder portion 24 in the barrel 22 is closed with a head portion 27. The head portion 27 has a discharge port 28 through which the kneaded substance is discharged.

The vent screw 23 is accommodated in the cylinder portion 24. The vent screw 23 receives a torque that is transmitted from the motor, not shown, and rotates in one direction. The vent screw 23 has a spirally twisted flight 29. The flight 29 integrally rotates with the vent screw 23 and continuously transports the kneaded substance supplied to the cylinder portion 24 toward the head portion 27. The kneaded substance receives a vacuum pressure from the vacuum pump 26 when transported to a position corresponding to the vent port 25. That is, negative pressure is generated in the cylinder portion 24 with the vacuum pump, whereby a gaseous substance or other volatile component that is contained in the kneaded substance is continuously suctioned and removed from the kneaded substance. The kneaded substance from which the gaseous substance or other volatile component has been removed is continuously discharged as a carbon fiber composite material to the outside of the continuous high shear processing apparatus 1 from the discharge port 28 in the head portion 27.

Next, the second extruder 3 will be described.

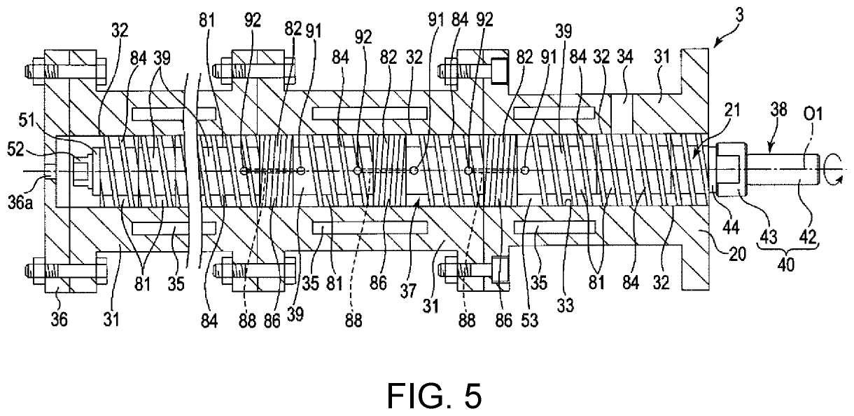

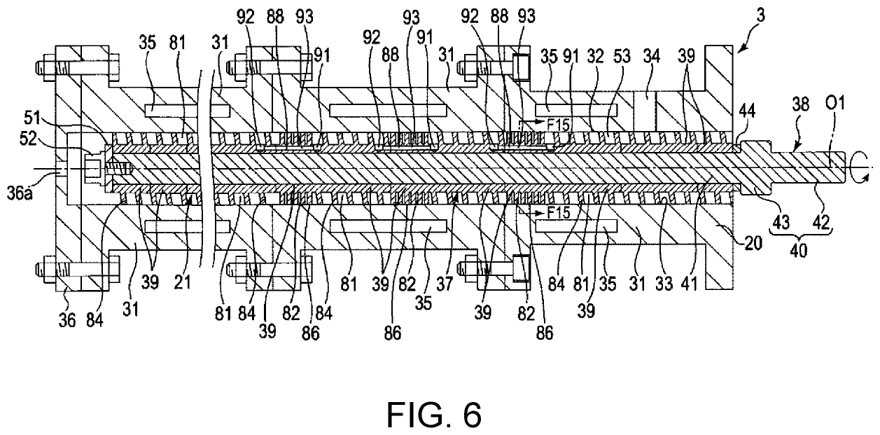

As shown in FIG. 5 and FIG. 6, the barrel 20 of the second extruder 3 has a straight tubular shape and is horizontally disposed. The barrel 20 is divided into a plurality of barrel elements 31.

The barrel elements 31 each have a cylindrical through hole 32. The barrel elements 31 are integrally bound by bolt fastening such that the individual through holes 32 coaxially continue. The through holes 32 in the barrel elements 31 cooperate with each other to regulate a cylindrical cylinder portion 33 inside the barrel 20. The cylinder portion 33 extends in the axial direction of the barrel 20.

A supply port 34 is formed at one end portion of the barrel 20 along the axial direction. The supply port 34 communicates with the cylinder portion 33, and the raw material blended with the first extruder 2 is continuously supplied to the supply port 34.

The barrel 20 includes a heater, not shown. The heater adjusts the temperature of the barrel 20 such that the temperature of the barrel 20 reaches an optimal value for the kneading of the raw material. Furthermore, the barrel 20 includes a coolant passage 35 through which a coolant, for example, water or oil, flows. The coolant passage 35 is disposed so as to surround the cylinder portion 33. The coolant flows along the coolant passage 35 and forcibly cools the barrel 20 when the temperature of the barrel 20 exceeds a predetermined upper limit value.

The other end portion of the barrel 20 along the axial direction is closed with a head portion 36. The head portion 36 has a discharge port 36a. The discharge port 36a is positioned opposite to the supply port 34 along the axial direction of the barrel 20 and is connected to the third extruder 4.

The screw 21 includes a screw main body 37. The screw main body 37 of the present embodiment is composed of one rotation shaft 38 and a plurality of cylindrical tubes 39.

The rotation shaft 38 includes a first shaft portion 40 and a second shaft portion 41. The first shaft portion 40 is positioned at the base end of the rotation shaft 38 that is present at one end portion of the barrel 20. The first shaft portion 40 includes a joint portion 42 and a stopper portion 43. The joint portion 42 is linked to a driving source such as a motor through a coupling, not shown. The stopper portion 43 is provided coaxially with the joint portion 42. The stopper portion 43 is larger than the joint portion 42 in diameter.

The second shaft portion 41 coaxially extends from an end face of the stopper portion 43 of the first shaft portion 40. The second shaft portion 41 is as long as substantially the entire length of the barrel 20 and has a front end that faces the head portion 36. A straight axial line O1 that coaxially penetrates the first shaft portion 40 and the second shaft portion 41 extends horizontally in the axial direction of the rotation shaft 38.

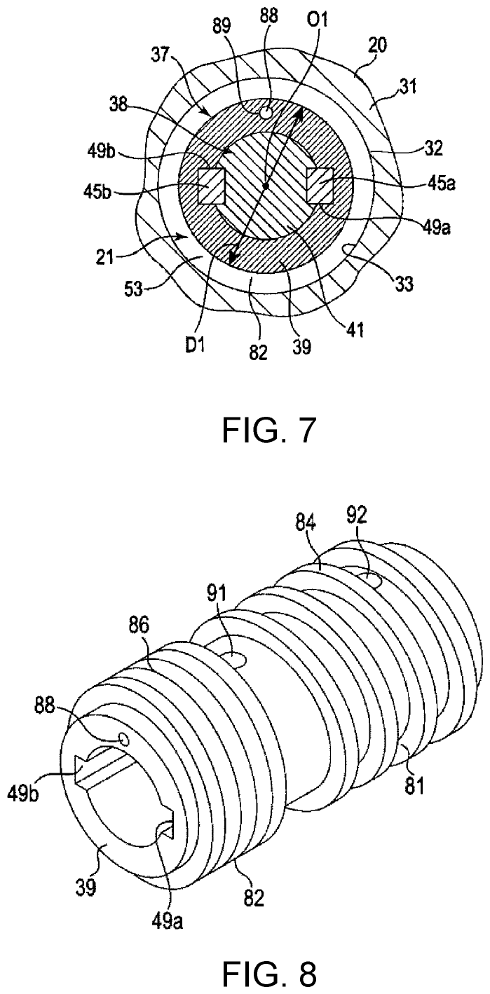

The second shaft portion 41 has a solid columnar shape that is smaller than the stopper portion 43 in diameter. As shown in FIG. 7, a pair of keys 45a and 45b is attached to the outer circumferential surface of the second shaft portion 41. The keys 45a and 45b extend in the axial direction of the second shaft portion 41 at positions 180° shifted in the circumferential direction of the second shaft portion 41.

As shown in FIG. 7 and FIG. 8, the individual tubes 39 are configured to be coaxially penetrated by the second shaft portion 41. A pair of key grooves 49a and 49b is formed on the inner circumferential surface of the tube 39. The key grooves 49a and 49b extend in the axial direction of the tube 39 at positions 180° shifted in the circumferential direction of the tube 39.

The tube 39 is inserted onto the second shaft portion 41 in a direction from the front end of the second shaft portion 41 in a state where the key grooves 49a and 49b are fitted into the keys 45a and 45b of the second shaft portion 41. In the present embodiment, a first collar 44 is interposed between the tube 39 firstly inserted onto the second shaft portion 41 and the end face of the stopper portion 43 of the first shaft portion 40. Furthermore, after all of the tubes 39 are inserted onto the second shaft portion 41, a fixation screw 52 is screwed into the front end surface of the second shaft portion 41 through a second collar 51.

Due to this screwing, all of the tubes 39 are tightened in the axial direction of the second shaft portion 41 between the first collar 44 and the second collar 51, and the end faces of the tubes 39 adjacent to each other are firmly fastened with no gap therebetween.

The screw main body 37 has a plurality of transport portions 81 for transporting the raw material and a plurality of barrier portions 82 for restricting the flow of the raw material. That is, the plurality of transport portions 81 is disposed at the base end of the screw main body 37 that corresponds to one end portion of the barrel 20, and the plurality of transport portions 81 is disposed at the front end of the screw main body 37 that corresponds to the other end portion of the barrel 20. Furthermore, between these transport portions 81, the transport portions 81 and the barrier portions 82 are disposed alternately side by side in the axial direction from the base end of the screw main body 37 toward the front end. Depending on the number of sets that are each composed of the transport portion 81 and the barrier portion 82, the number of times of repetition of a kneading step of the resin and the recycled carbon fibers is determined.

The supply port 34 of the barrel 20 is open toward the transport portion 81 disposed on the base end side of the screw main body 37.

Each transport portion 81 has a spirally twisted flight 84. The flight 84 overhangs a transport path 53 from the outer circumferential surface that is along the circumferential direction of the tube 39. The flight 84 is twisted so as to transport the raw material from the base end of the screw main body 37 toward the front end when the screw 21 rotates to the left counterclockwise at the time of being viewed from the base end of the screw main body 37. That is, the flight 84 is twisted to the right such that the twist direction of the flight 84 becomes the same as a right-handed screw.

Each barrier portion 82 has a spirally twisted flight 86. The flight 86 overhangs the transport path 53 from the outer circumferential surface that is along the circumferential direction of the tube 39. The flight 86 is twisted so as to transport the raw material from the front end of the screw main body 37 toward the base end when the screw 21 rotates to the left counterclockwise at the time of being viewed from the base end of the screw main body 37. That is, the flight 86 is twisted to the left such that the twist direction of the flight 86 becomes the same as a left-handed screw.

The twist pitch of the flight 86 of each barrier portion 82 is set to be equal to or smaller than the twist pitch of the flight 84 of the transport portion 81. Furthermore, a slight clearance is secured between the apex of each of the flights 84 and 86 and the inner circumferential surface of the cylinder portion 33 of the barrel 20.

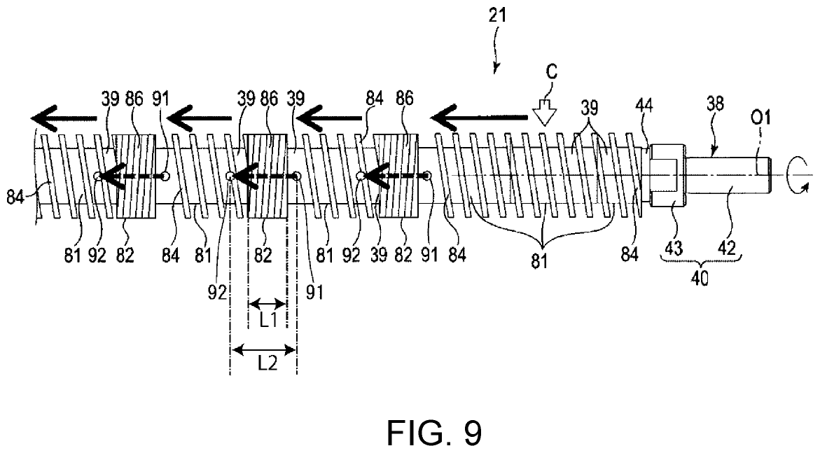

As shown in FIG. 5, FIG. 6 and FIG. 9, the screw main body 37 has a plurality of passages 88 that extends in the axial direction of the screw main body 37. When one barrier portion 82 and two transport portions 81 that sandwich the barrier portion 82 are regarded as one unit, the passage 88 is formed in the tubes 39 below both transport portions 81 across the barrier portion 82 of each unit. In this case, the passages 88 are arrayed in a row at predetermined intervals (for example, equal intervals) on the same straight line along the axial direction of the screw main body 37.

Furthermore, the passage 88 is provided at a position eccentric with respect to the axial line O1 of the rotation shaft 38 in the tube 39. In other words, the passage 88 deviates from the axial line O1 and is configured to revolve around the axial line O1 when the screw main body 37 rotates.

As shown in FIG. 7, the passage 88 is, for example, a hole having a circular cross-sectional shape. The passage 88 is configured as a hollow space that allows only the circulation of the raw material. A wall surface 89 of the passage 88 does not rotate around the axial line O1, but revolves around the axial line O1 when the screw main body 37 rotates.

In a case where a hole having a circular cross-sectional shape is used as the passage 88, the diameter of the circle needs to be set to, for example, approximately 2-6 mm. In addition, the distance (length) of the passage 88 needs to be set to, for example, approximately 15-90 mm. From the viewpoint of smoothly passing the recycled carbon fibers and imparting a sufficient shearing force to disperse the recycled carbon fibers at the time of passing the recycled carbon fibers, the diameter of the circle of the cross section of the passage 88 is preferably 3-5 mm, and the distance of the passage 88 is preferably 20-40 mm.

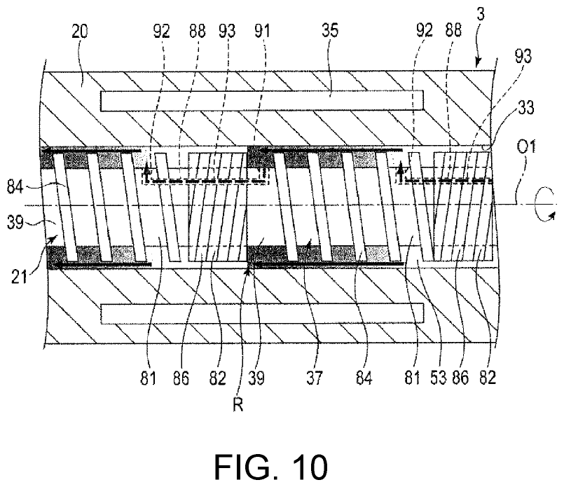

As shown in FIG. 10, each passage 88 has an inlet 91, an outlet 92 and a passage main body 93 that communicates with the inlet 91 and the outlet 92. The inlet 91 and the outlet 92 are provided close to both sides of one barrier portion 82. In a different way, in one transport portion 81 between two adjacent barrier portions 82, the inlet 91 is open on the outer circumferential surface near the downstream end of the transport portion 81, and the outlet 92 is open on the outer circumferential surface near the upstream end of the transport portion 81. The passage main body 93 does not communicate with the inlet 91 and the outlet 92 that are open on the outer circumferential surface of one transport portion 81. The inlet 91 is made to communicate with the outlet 92 in the transport portion 81 on the downstream side adjacent through the barrier portion 82, and the outlet 92 is made to communicate with the inlet 91 in the transport portion 81 on the upstream side adjacent through the barrier portion 82.

In FIG. 10, the filling rates of the raw material at places corresponding to, among the transport portions 81, the transport portions 81 in the screw main body 37 are indicated by gradations. That is, in the transport portion 81, the filling rate of the raw material increases as the color tone becomes darker. As is clear from FIG. 10, in the transport portion 81, the filling rate of the raw material increases toward the barrier portion 82, and the filling rate of the raw material reaches 100% immediately before the barrier portion 82.

Therefore, “raw material pool R” where the filling rate of the raw material reaches 100% is formed immediately before the barrier portion 82. In the raw material pool R, the flow of the raw material is blocked, whereby the pressure of the raw material increases. The raw material having an increased pressure continuously flows into the passage 88 from the inlet 91 open on the outer circumferential surface of the transport portion 81 and continuously circulates in the passage 88 as shown by a broken arrow in FIG. 10.

The cross-sectional area of the passage that is regulated by the diameter of the passage 88 is significantly smaller than the annular cross-sectional area of the transport portion 81 along the radial direction of the cylinder portion 33. In a different way, the expanding region that is based on the diameter of the passage 88 is significantly smaller than the expanding region of the annular transport path 53. Therefore, the raw material is abruptly squeezed when flowing into the passage 88 from the inlet 91, whereby a stretching action is imparted to the raw material.

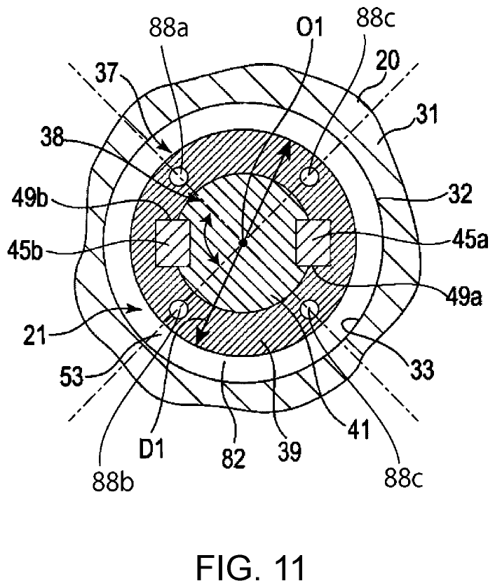

As shown in FIG. 11, in the screw main body 37, a plurality of the passages 88 may be provided in parallel. In the case of providing a plurality of the passages 88, the passages 88 are preferably evenly disposed in the screw main body 37. When the plurality of passages 88 is evenly disposed, a pressure and a shearing force that are applied to the kneaded resin and recycled carbon fibers become uniform, and it is possible to suppress the resin being degraded by a local temperature increase. In the case of evenly providing the plurality of passages 88, the inlets 91 and the outlets 92 (refer to FIG. 8) of the passages 88 are also evenly provided on the outer circumferential surface of the screw main body 37, respectively.

FIG. 11 shows an example in which four passages 88a, 88b, 88c and 88d are provided in parallel in the screw main body 37. As shown in the same drawing, the fact that a plurality of the passages 88 is evenly disposed refers to the fact that the angles between lines that connect the axial line (central point) O1 of the cross section of the screw main body 37 and the passages 88 adjacent to each other are equal to each other. The angles between the lines that connect the axial line O1 and the adjacent passages 88 are 90° in the case of four passages 88 and are 180° in the case of two passages 88. D1 indicates the outer diameter of the screw main body 37.

The raw material supplied to the second extruder 3 is injected onto the outer circumferential surface of the transport portion 81 positioned on the base end side of the screw main body 37 as shown by an arrow C in FIG. 9. At this time, when the screw 21 rotates to the left counterclockwise at the time of being viewed from the base end of the screw main body 37, the flight 84 of the transport portion 81 continuously transports the raw material toward the front end of the screw main body 37 as shown by solid line arrows in FIG. 9.

In the present embodiment, the plurality of transport portions 81 and the plurality of barrier portions 82 are alternately arranged in the axial direction of the screw main body 37, and the plurality of passages 88 is arranged in the axial direction of the screw main body 37 at equal intervals. Therefore, the raw material injected into the screw main body 37 from the supply port 34 is continuously transported in a direction from the base end to the front end of the screw main body 37 while repeatedly receiving a shearing action and a stretching action alternately as shown by the arrows in FIG. 9 and FIG. 10. Therefore, the degree of the kneading of the raw material is intensified, and the dispersion of the resin and the recycled carbon fibers in the raw material is accelerated.

At the time of accelerating the dispersion of the resin and the recycled carbon fibers, if the fiber lengths of the recycled carbon fibers become too short, there are cases where the tensile strength of the composite material becomes low. Therefore, from the viewpoint of producing a composite material having high tensile strength, conditions for accelerating the dispersion are adjusted such that the aspect ratio of the recycled carbon fiber becomes 3.4-4.0 and preferably becomes 3.5-3.9 and the fiber length (D50) of the recycled carbon fibers becomes 100 μm or more and preferably becomes 105 μm or more.

As the conditions, the inner diameter and distance of the passage 88, the number of times of the shearing action and the stretching action being alternately repeated and the like can be exemplified. For example, when the screw main body 37 including four passages each having an inner diameter of 4 mm and a distance of 30 mm is used, the rotation speed is set to 200-500 (rotations/minute), and the number of times of transport restricted (number of times of repetition) is set to twice to four times, it is possible to produce a carbon fiber composite material having high strength and elasticity. In the present invention, the number of times of transport restricted is the same as the number of the barrier portions 82 that are provided in the second extruder 3.

The screw 21 receives a torque from the driving source and rotates. The rotation speed of the screw 21 suitable for the production of a carbon fiber composite material having favorable mechanical characteristics differs depending on the outer diameter of the screw 21. Ordinarily, as the outer diameter of the screw 21 becomes smaller, the suitable rotation speed tends to become faster. In the case of using the screw 21 having an outer diameter of 30 mm or more and 50 mm or less, the rotation speed of the screw 21 is preferably 100 rpm to 1000 rpm, more preferably 150 rpm to 600 rpm and still more preferably 200 rpm to 400 rpm.

In the present embodiment, as shown in FIG. 9, the transport direction of the raw material in the transport portions 81, which is indicated by the solid arrows, and the circulation direction of the raw material in the passages 88, which is indicated by the broken arrows, are the same as each other. In addition, the inlet 91 of the passage 88 is provided in the vicinity of the end portion on the downstream side (front end side, left side in FIG. 9) of the transport portion 81, and the outlet 92 is provided in the vicinity of the end portion on the upstream side of the transport portion 81 that is present on the downstream side adjacent to the above-described transport portion 81 through the barrier portion 82. As described above, since a length L2 of the passage 88 across the barrier portion 82 is configured to be short, the flow resistance becomes low when the raw material passes through the passage 88. Therefore, the production method of the present embodiment is suitable for the production of resins for which a highly viscous raw material is used and is preferable as a method for producing carbon fiber composite materials containing a high concentration of recycled carbon fibers. In addition, it is also possible to produce carbon fiber composite materials containing a high concentration of a fiber material such as unused carbon fibers or glass fibers (GF) in place of recycled carbon fibers.

The length L2 of the passage 88 needs to be larger than a length L1 of the barrier portion 82 that the passage 88 crosses; however, from the viewpoint of decreasing the flow resistance when the raw material passes through the passage 88, the length L2 is preferably twice or less, more preferably 1.5 times or less and still more preferably 1.3 times or less the length L1 of the barrier portion 82 that the passage 88 crosses.

In addition, the raw material that has reached the front end of the screw main body 37 already has become a kneaded substance that has been sufficiently kneaded and is continuously supplied to the third extruder 4 from the discharge port 36a, and the gaseous substance or another volatile component that is contained in the kneaded substance is continuously removed from the kneaded substance.

### EXAMPLES

### Examples 1 to 14 and Comparative Example 1

Recycled carbon fibers (appropriately referred to as RCFs) and a thermoplastic resin raw material were kneaded using a continuous high shear processing apparatus described in the embodiment with reference to FIG. 1 to FIG. 11, thereby producing carbon fiber composite materials. As shown in Table 1, a commercially available product (manufactured by Carbon Fiber Recycle Industry Co., Ltd., TORAY T800-equivalent grade primary heated product) was used as the recycled carbon fibers, a polyamide 6 resin (PA6, trade name: AMILAN CM1017, manufactured by Toray Industries, Inc.) or a polyphenylene sulfide resin (PPS, trade name: TORELINAA900B1, manufactured by Toray Industries, Inc.) was used as the thermoplastic resin.

In the production of the carbon fiber composite materials, the recycled carbon fibers and the thermoplastic resin were supplied to a first extruder 2 in which the screw effective length of a kneading portion 12 with respect to the screw effective length (screw length/screw diameter) 48 was set to eight and preliminarily kneaded, thereby generating a material in a molten state. In addition, the material in a molten state was continuously supplied from the first extruder 2 to a second extruder 3 as a raw material for the second extruder 3, thereby producing a carbon fiber composite material.

In the production of the carbon fiber composite materials, the second extruder 3 including a screw 21 with the following specification was used, and the content (wt %) of RCFs, the passage length (mm), the number of passages provided in parallel, the number of times of a treatment (times) and the rotation speed (rotations/minute) were set as shown in Table 1 and Table 2.

Screw diameter (outer diameter): 48 mm

Screw effective length (L/D): 6.25-18.75

Amount of raw material supplied: 10 kg/hour

Set barrel temperature: 250° C.

Cross-sectional shape of inlet, outlet and passage main body: Circular shape with diameter of 4 mm

Test pieces were produced from the carbon fiber composite materials produced under the above-described conditions, and the tensile strength, the tensile elastic modulus, the flexural strength, the flexural modulus, the average fiber lengths (D50) of RCFs in the composite materials and the aspect ratio were measured by the following methods. The results are shown in Table 1 and Table 2.

### <Tensile Strength>

It was measured based on JIS K 7161.

As a test piece, a dumbbell-shaped test piece that was 10 mm in central width, 175 mm in length and 4 mm in thickness was produced by injection molding. As the shape of the test piece, a dumbbell shape 1A was used. In the tensile test, a table-top precision universal tester (AUTOGRAPH AG-50 kN manufactured by Shimadzu Corporation) was used, the crosshead speed was set to 5 mm/minute, and a load was applied until the test piece broke. The tensile strength was calculated from the following calculation equation.

F=P/W×D

F: Strength (MPa)

P: Fracture load (MPa)

W: Width of test piece (mm)

D: Thickness of test piece (mm)

<Tensile Elastic Modulus>

A tensile test was performed based on JIS K 7161. The tensile elastic modulus was obtained from the slope of a stress-strain curve between two points of strains ε1 and ε2 in a stress-strain relationship obtained by the test. The strain was measured with an extensometer (manufactured by Epsilon Technology Corp.) calibrated before the measurement.

E=((σ2−σ1)/(ε2−ε1))/1000

E: Elasticity (GPa)

ε1: 0.1% Strain (0.0001)

ε2: 0.3% Strain (0.0003)

α1: Stress at ε1 (MPa)

α2: Stress at ε2 (MPa)

<Flexural Strength>

It was measured based on JIS K 7171.

As a test piece, a dumbbell-shaped test piece that was 10 mm in width, 80 mm in length and 4 mm in thickness was produced by injection molding. As a flexural test, three-point flexural was performed, and the test was performed using the table-top precision universal tester (AUTOGRAPH AG-50 kN manufactured by Shimadzu Corporation). The crosshead speed was set to 2 mm/minute, and a load was applied until the test piece broke. The flexural strength was calculated from the following calculation equation.

F=3×P×L/2×W×D²

F: Strength (MPa)

P: Fracture load (MPa)

L: Distance between fulcrums (64 mm)

W: Width of test piece (mm)

D: Thickness of test piece (mm)

### <Flexural Modulus>

A flexural test was performed based on JIS K 7171. The flexural modulus was obtained from the slope of a stress-strain curve between two points of strains ε1 and ε2 in a stress-strain (elongation) relationship obtained by the test.

E=((σ2−σ1)/(ε2−ε1)/1000

E: Elasticity (GPa)

ε1: 0.05% Strain (0.0005)

ε2: 0.25% Strain (0.0025)

σ1: Stress at ε1 (MPa)

σ2: Stress at ε2 (MPa)

<Average Fiber Length (D50) and Aspect Ratio>

From each of the kneaded substances obtained under the individual conditions, the resin was splashed in an inert atmosphere at 500° C. or higher, and the carbon fibers were collected. The obtained carbon fibers were injected into a laser diffraction/scattering-type particle size distribution measuring instrument (MT3300II manufactured by MicrotracBEL Corp.), the fiber distribution was measured, the median diameter (D50) was obtained, the circle-equivalent diameter and the major axis were measured by image analysis, and the aspect ratio was obtained.

TABLE 1

| | Example 1 | Example 2 | Example 3 | Example 4 | Example 5 | Example 6 | Example 7 |
|---|---|---|---|---|---|---|---|
| PA6 | 50 | 40 | 35 | 50 | 40 | 40 | 40 |
| PPS | — | — | — | — | — | — | — |
| RCF | 50 | 60 | 65 | 50 | 60 | 60 | 60 |
| Passage length(mm) | 45 | 45 | 45 | 30 | 30 | 30 | 30 |
| Number of passages | 1 | 1 | 1 | 1 | 1 | 1 | 1 |
| Number of times of | 7 | 7 | 7 | 2 | 2 | 2 | 2 |
| repetition | | | | | | | |
| Rotation speed | 500 | 500 | 700 | 500 | 500 | 500 | 300 |
| (rotations/minute) | | | | | | | |
| Tensile strength | 197 | 184 | 170 | 189 | 185 | 184 | 197 |
| (MPa) | | | | | | | |
| Tensile elastic | | | | | | | |
| modulus (GPa) | 27.3 | 31.2 | 32.9 | 29.5 | 32.5 | 32.3 | 33.4 |
| Flexural strength | — | 237 | — | — | — | 236 | 243 |
| (MPa) | | | | | | | |
| Flexural modulus | — | 23.8 | — | — | — | 23.8 | 23.5 |
| (GPa) | | | | | | | |
| D50 (μm) | — | 88.4 | — | — | — | 106 | 103 |
| Aspect ratio | — | 3.25 | — | — | — | 3.30 | 3.43 |

TABLE 2

| | Example | Example | Example | Example | Example | Example | Example | Comparative |
|---|---|---|---|---|---|---|---|---|
| | 8 | 9 | 10 | 11 | 12 | 13 | 14 | Example 1 |
| PA6 | 40 | 35 | 40 | 40 | 40 | 35 | — | 70 |
| PPS | — | — | — | — | — | — | 40 | — |
| RCF | 60 | 65 | 60 | 60 | 60 | 65 | 60 | 30 |
| Passage length(mm) | 30 | 30 | 30 | 30 | 30 | 30 | 30 | 45 |
| Number of passages | 2 | 2 | 4 | 4 | 4 | 4 | 1 | 1 |
| Number of times of | 2 | 2 | 2 | 2 | 2 | 2 | 2 | 7 |
| repetition | | | | | | | | |
| Rotation speed | 500 | 400 | 500 | 300 | 200 | 300 | 250 | 100 |
| (rotations/minute) | | | | | | | | |
| Tensile strength | 195 | 204 | 199 | 201 | 212 | 209 | 206 | 179 |
| (MPa) | | | | | | | | |
| Tensile elastic | 33.7 | 34.7 | 32.3 | 32.6 | 33.3 | 33.1 | 35.8 | 19.5 |
| modulus (GPa) | | | | | | | | |
| Flexural strength | 234 | — | 219 | 221 | 249 | — | 264 | — |
| (MPa) | | | | | | | | |
| Flexural modulus | 23.3 | — | 23.9 | 23.7 | 23.2 | — | 283 | — |
| (GPa) | | | | | | | | |
| D50 (μm) | — | — | — | — | 108 | — | — | — |
| Aspect ratio | — | — | — | — | 3.67 | — | — | — |

Recycled carbon fibers (RCFs) and a thermoplastic resin raw material were kneaded using the same raw materials in the same amounts blended as in Examples 1 to 3 in Table 1 using a TEM twin screw extruder (manufactured by Shibaura Machine Co., Ltd.) in place of the continuous high shear processing apparatus. However, since it was not possible to continuously produce carbon fiber composite materials stably, these results (Comparative Examples 2 to 4) are not shown in Table 1 and Table 2.

In the case of using the same raw materials as in Example 1 (RCFs: 50 wt %), it was possible to prepare a carbon fiber composite material (Comparative Example 2), the tensile strength was 265 (MPa) and the tensile elastic modulus was 31 (GPa), but a number of tab portions fractured during the tests. In addition, the discharged carbon fiber composite material was cut in the middle during the production, and thus stable continuous production was not possible. As a result, with an ordinary TEM twin screw extruder, it was not possible to continuously produce carbon fiber composite materials for which the same raw materials as in Examples 1 to 3 (RCFs: 50-65 wt %) were used (Comparative Examples 2 to 4). As described above, it was difficult to produce the carbon fiber composite material of the present invention using an ordinary TEM twin screw extruder.

As shown by Examples 1 to 14 in Table 1, the use of the continuous high shear processing apparatus made it possible to continuously produce carbon fiber composite materials in which the content of the recycled carbon fibers was 50-65 wt %. Comparison between the carbon fiber composite materials prepared from the same raw materials using the continuous high shear processing apparatus in Example 1 and using the TEM twin screw extruder shows a tendency that the tensile strength decreased in the carbon fiber composite material obtained using the continuous high shear processing apparatus more than in the carbon fiber composite material produced using the TEM twin screw extruder (Example 1: 197 MPa, Comparative Example 2: 265 MPa). This is considered to be because the fiber lengths of the recycled carbon fibers became short in the step of highly dispersing the resin and the recycled carbon fibers. However, it was possible to improve the tensile elastic modulus of the carbon fiber composite material by increasing the content of the recycled carbon fibers.

The tensile strength of the carbon fiber composite material is affected by the production condition such as the number of times of repetition or the rotation speed. Among the production conditions, the rotation speed had a large influence.

A tendency that the tensile strength of the carbon fiber composite material was improved by increasing the number of passages for imparting a shearing force to the raw materials was admitted. In order to produce a carbon fiber composite material having high tensile strength, it is preferable to provide a plurality of passages and decrease the rotation speed at the time of high shear processing.

The aspect ratio and fiber length (D50) of RCFs that are contained in the carbon fiber composite material serve as indexes for evaluating the tensile strength of the carbon fiber composite material. In order to increase the tensile strength of the carbon fiber composite material, it was effective to prevent the fiber lengths of RCFs from becoming too short due to the high shear processing.

Carbon fiber composite materials having favorable tensile strength and tensile elastic modulus were also favorable in terms of the flexural strength and the flexural modulus.

For a molded body produced using the carbon fiber composite material of Example 12, the anisotropy was measured by the following method. The measurement results are shown in

Table 3.

<Evaluation of Anisotropy>

A 200 mm×200 mm flat plate having a thickness of 4 mm was produced by injection molding, a dumbbell-shaped test piece used in the tensile test was cut from the central portion in a direction (MD) in which the molten resin flowed in a mold and in a transverse direction (TD) thereof by mechanical processing, and the tensile strength (JIS K 7161) and the tensile elastic modulus (JIS K 7161) were measured by the above-described methods.

### Comparative Example 5

A flat plate having the same shape was produced by injection molding using, in place of the carbon fiber composite material of Example 12, a commercially available carbon fiber composite material (trade name: PYLOFIL, manufactured by Mitsubishi Chemical Corporation, unused carbon fibers: 30% and PA6: 70%), and the anisotropy was measured under the same conditions by the same method as in Example 12. The measurement results are shown in Table 4.

TABLE 3

| | | Example 12 |
|---|---|---|
| Vertical direction (MD) | Tensile strength | 105 |
| | Tensile elastic modulus | 15 |
| Transverse direction (TD) | Tensile strength | 91.3 |
| | Tensile elastic modulus | 13.5 |
| TD/MD | Tensile strength | 0.87 |
| | Tensile elastic modulus | 0.90 |

TABLE 4

| | | Comparative Example 5 |
|---|---|---|
| Vertical direction (MD) | Tensile strength | 196 |
| | Tensile elastic modulus | 18.6 |
| Transverse direction (TD) | Tensile strength | 11.1 |
| | Tensile elastic modulus | 9.36 |
| TD/MD | Tensile strength | 0.57 |
| | Tensile elastic modulus | 0.50 |

The anisotropy of the molded body can be evaluated with a difference in the characteristics of the molded body when cut in different directions, and, as the ratio (TD/MD) of the characteristics in the transverse direction (TD) to the characteristics in the vertical direction (MD) approximates 1.0, the anisotropy of the molded body becomes smaller. As shown in Table 3 and Table 4, the anisotropy of the tensile strength and the tensile elastic modulus was smaller in the molded body of Example 12 than in the molded body of Comparative Example 5. It can be said that the use of the continuous high shear processing apparatus highly disperses RCFs even when the RCFs are blended at a high concentration and suppresses the anisotropy of the carbon fiber composite material.

### Examples 12 and 14 and Comparative Examples 5 to 9

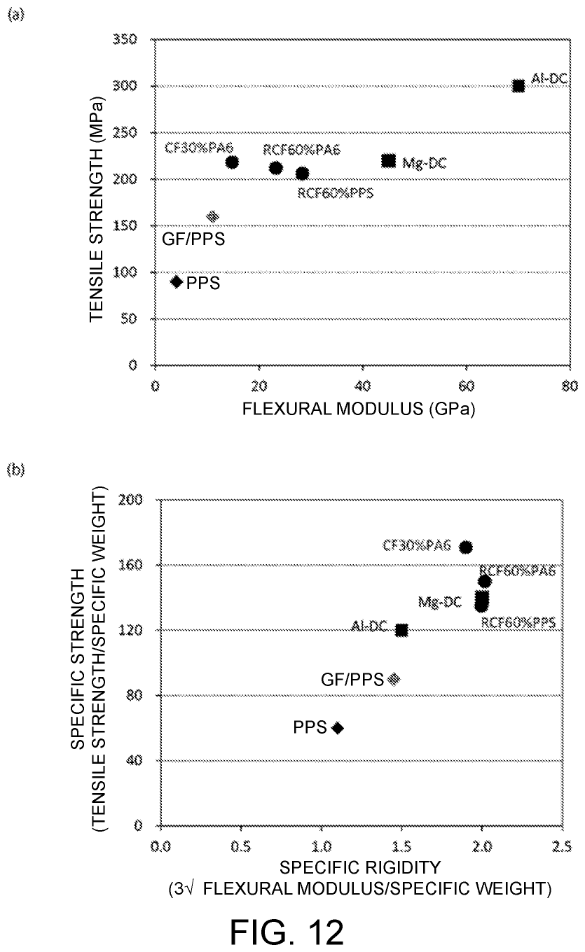

The flexural modulus, tensile strength, specific rigidity and specific strength of the molded bodies of Example 12 and 14 were measured. In addition, for the molded body of each of a carbon fiber composite material containing 30% of unused carbon fibers and 70% of PA6 (Comparative Example 5), a composite material containing glass fibers and PPS (Comparative Example 6), a molded body containing PPS (Comparative Example 7), die-cast aluminum (Comparative Example 8, Al-DC) and die-cast magnesium (Comparative Example 9, Mg-DC), the flexural modulus, tensile strength, specific rigidity and specific strength were measured in the same manner. These flexural modulus, tensile strength, specific rigidity and specific strength are collectively shown in Table 5, FIG. 12(a) and FIG. 12(b). The specific rigidity is a value standardized by dividing the third root of the flexural modulus by the specific weight, and the specific strength is a value standardized by dividing the tensile strength by the specific weight.

<Evaluation of Conductive Properties>

The conductivity of the carbon fiber composite materials of Example 12 and Comparative Example 5 were measured based on JIS K 7194. The results are shown in Table 5.

In the measurement of the conductivity, a flat plate was produced by injection molding as a test piece for the measurement. The conductivity was measured at five points in each test piece using a low-resistance resistivity meter. Since five resistivity values are calculated from one test piece, 15 resistivity values are calculated. A value obtained by averaging these 15 resistivity values was regarded as the conductivity.

Production condition: Temperature of 260° C.,

Test piece: Length of 60 mm, width of 60 mm and thickness of 4 mm

TABLE 5

| | | | | | | Comparative | Comparative |
|---|---|---|---|---|---|---|---|
| | | | Comparative | Comparative | Comparative | Example 8 | Example 9 |
| | Example 12 | Example 14 | Example 5 | Example 6 | Example 7 | Al-DC | Mg-DC |
| CF | — | — | 30 | — | — | — | — |
| RCF | 60 | 60 | — | — | — | — | — |
| Glass fiber | — | — | — | 30 | — | — | — |
| PA6 | 40 | — | 70 | — | — | — | — |
| PPS | — | 40 | — | 70 | 100 | — | — |
| Flexural modulus | 23.2 | 28.3 | 23 | 11 | 4 | 70 | 45 |
| (GPa) | | | | | | | |
| Tensile strength | 212 | 206 | 255 | 160 | 90 | 300 | 220 |
| (MPa) | | | | | | | |
| Specific rigidity | 2.0 | 2.0 | 2.2 | 1.5 | 1.1 | 1.5 | 2.0 |
| Specific strength | 145 | 135 | 200 | 90 | 60 | 120 | 140 |
| Conductivity | 2.82 | — | 0.07 | — | — | — | — |
| (S/cm²) | | | | | | | |

As shown in Table 5, FIG. 12(a) and FIG. 12(b), in the carbon fiber composite materials of Examples 12 and 14, the content of the recycled carbon fibers was set to 60 wt %, whereby it was possible to realize a high tensile strength of more than 200 (MPa). In addition, the specific strength and specific rigidity of the carbon fiber composite material of Example 12 were equal to or higher than those of die-cast aluminum (Al-DC) and die-cast magnesium (Mg-DC).

In addition, the carbon fiber composite material of Example 12 had extremely high conductivity. This is considered to be because the carbon fiber composite material of Example 12 contained the recycled carbon fibers at a high concentration of 60 wt %. That is, as described above, the recycled carbon fibers (RCFs) have a lower affinity to the resin than unused carbon fibers (CFs) and are not covered with the resin layer on the surface. Therefore, the use of the recycled carbon fibers broadens an area where the conductive recycled carbon fibers come into direct contact with each other. Therefore, it can be said that, in the carbon fiber composite material of Example 1 containing 60 wt % of the recycled carbon fibers (RCFs), it was possible to realize extremely high conductive properties that were approximately 40 times higher than those of the carbon fiber composite material of Comparative Example 5 containing 30 wt % of the unused carbon fibers (RCFs).

As described above, the carbon fiber composite material of the present invention has extremely high conductive properties compared with materials in which conventional unused carbon fibers (CFs) are used. Therefore, the carbon fiber composite material of the present invention is useful as, for example, a material of molded bodies for which static protection, electromagnetic wave-shielding properties or heat dissipation properties are required.

### REFERENCE SIGNS LIST

1: High shear processing apparatus
2: First extruder
3: Second extruder
4: Third extruder
6: Barrel
7a and 7b: Screw
8: Cylinder portion
9: Supply port
11: Feeding portion
12: Kneading portion
13: Pumping portion
14: Flight
15: Disc
16: Flight
20: Barrel
21: Screw
22: Barrel
23: Vent screw
24: Cylinder portion
25: Vent port
26: Vacuum pump
27: Head portion
28: Discharge port
29: Flight
31: Barrel element
32: Through hole
33: Cylinder portion
34: Supply port
35: Coolant passage
36: Head portion
36a: Discharge port
37: Screw main body
38: Rotation shaft
39: Tube
40: First shaft portion
41: Second shaft portion
42: Joint portion
43: Stopper portion
44: First collar
45a and 45b: Key
49a and 49b: Key groove
51: Second collar
52: Fixation screw
53: Transport path
81: Transport portion
82: Barrier portion
84 and 86: Flight
88, 88a, 88b, 88c and 88d: Passage
89: Wall surface
91: Inlet
92: Outlet
93: Passage main body
O1: Axial line

1. A carbon fiber composite material comprising:
a resin; and
recycled carbon fibers,
wherein a content of the recycled carbon fibers is 50-70 wt %.

2. The carbon fiber composite material according to claim 1, wherein an average aspect ratio of the recycled carbon fibers is 3.4-4.0.

3. The carbon fiber composite material according to claim 2, wherein a fiber length D50 of the recycled carbon fibers is 100-150 μm.

4. The carbon fiber composite material according to claim 3, wherein the resin is a thermoplastic resin.

5. A molded body molded by injection molding of the carbon fiber composite material according to claim 1.

6. A method for producing a carbon fiber composite material, comprising:
melting, kneading and continuously discharging a raw material containing a resin and recycled carbon fibers,
wherein the raw material contains 50-70 wt % of the recycled carbon fibers,
when the raw material is transported along an outer circumferential surface of a screw main body having a passage therein,
transport of the raw material is restricted by a barrier portion provided on the outer circumferential surface, a shearing force is applied to the raw material with the screw main body, and a stretching force is applied to the raw material by passing the raw material from an inlet of the passage provided on the outer circumferential surface to an outlet of the passage.

7. The method for producing a carbon fiber composite material according to claim 6, wherein a plurality of the passages is provided in parallel inside the screw main body.

8. The method for producing a carbon fiber composite material according to claim 6, wherein a rotation speed of the screw main body is 200-500 rotations/minute, and the number of times of restricting the transport of the raw material is twice to four times.
